(19) United States
(12) Patent Application Publication
(10) Pub. No.: US 2001/0034613 A1
(43) Pub. Date: Oct. 25, 2001

(54) Method for acquiring and analyzing a list of a patient's prescription medications

(76) Inventor: Reid M. Rubsamen, Alamo, CA (US)

Correspondence Address: Karl Bozicevic, BOZICEVIC, FIELD & FRANCIS LLP, Suite 200, 200 Middlefield Road, Menlo Park, CA, 94025, US

(21) Appl. No.: 09/782,979

(22) Filed: Feb. 13, 2001

Related U.S. Application Data
(60) Provisional application No. 60/182,292, filed on Feb. 14, 2000.

(51) Int. Cl. G06F 17/60

(52) U.S. Cl. 705/2

(57) ABSTRACT

A computer system for obtaining, analyzing and providing information to a community of user patients regarding their medication is disclosed. The system is provided by means of world wide web access and generates a user patient screen prompting the manual entry of data relating to the use patient and drugs being taken. The data are analyzed and results are provided to the user patient and/or the caregiver including drug-drug interactions, drug pricing, alternative medications and possible adjustments in the dosing regimen of the user patient.

### CROSS-REFERENCE

This application claims the benefit of U.S. Provisional Application No. 60/182,292 filed Feb. 14, 2000, which application is incorporated herein by reference.

### FIELD OF THE INVENTION

The present invention relates to a software method of acquiring and analyzing a list of prescription medications taken by patients. More particularly, to perform this acquisition and analysis using the Internet.

### BACKGROUND OF THE INVENTION

The Internet has enabled client-server based transactions to occur over a virtually unlimited geographical area. The client-server transaction allows small home computers to directly access programs and data on large remote computers. Web-based applications programs written in Hypertext Markup Language (HTML) allow people without specialized computer training to navigate through server environments at will. Because of the connectivity offered by the World Wide Web and the ease of use afforded by HTML applications which provide access to server functions, large databases containing specialized information are now available to a wider audience than ever before.

Two main activities currently taking place on the World Wide Web are commerce and education. The role of advertising in commerce has blended these two activities. In particular, a major objective of web based commercial enterprises is to attract visitors to the site where they can be exposed to advertisements educating them about the value of the site's products and services. The need to attract visitors to commercial sites has been so extreme, that some sites are actually paying customers either in cash or by providing goods and services at a discount so substantial that each sales event is associated with a net loss for the sellers.

Many patients who take medications are confused about the role of the individual drugs prescribed by their doctor, potential interactions between medications and recent advances in therapeutics which might make their current treatment regimen obsolete. Although a periodic of a patient's entire medication regimen would be appropriate, this seldom occurs for a variety of reasons not the least of which is a lack of motivation by the patient and her physician. If patients or their physicians could be motivated to periodically subject their current pharmaceutical treatment regimen to scrutiny, safer and/or more efficacious therapy could result.

Much of the educational material disseminated to physicians and patients regarding drug therapy comes from the pharmaceutical industry. Drug companies spend considerable resources keeping detail representatives in the field whose primary responsibility is to teach physicians the potential benefits of the products sold by their employers. In addition, drug companies also spend large dollars on direct-to-patient advertising. These messages are necessarily indirect owing to regulatory restrictions regarding what can and cannot be said to patients about ethical (i.e. prescription) medications. A significant requirement for a detailed advertising campaign directed at patients is that the full package insert, including potential problems which may be associated with treatment with the drug being promoted, must accompany the advertisement.

These activities are expensive. In addition, much of this advertising is open loop and it is by no means certain that the desired target population has in fact been adequately addressed by the advertising campaign. Targeted marketing is the goal of these advertising campaigns. Patient profiling is the key to targeted marketing. The single most valuable descriptor of a patient who is undergoing treatment in the healthcare system is the list of medications which that patient is taking and, preferably, the dosing regimens for those medications. The present invention describes methods for acquiring this information from patients and analyzing it in a way so as to facilitate targeted marketing of specific pharmaceuticals to those patients.

### SUMMARY OF THE INVENTION

Two elements are essential to promote patient participation in supplying their list of prescription medications to a site. First, there must be returned value associated with disclosure of the list. Second, the process by which the list is entered must be simple.

Once the list of medications has been entered by the patient (the Patient Medication List) into the client application, the Hypertext Transfer Protocol is used by the client browser or other client application to upload the patient medication list into the server. A set of value functions is then applied to the list, giving the patient valuable information regarding their current therapy.

Specific value functions are being employed to encourage patients to communicate their complete list of current medications. These include (a) a list of potential drug-drug interactions which may complicate therapy (b) a scan of a wide variety of retail sources of the listed medications directing the patient to the lowest cost source for each drug (c) recent information from drug companies, government sources and publications regarding individual medications that the patient is taking (d) a comparison of the prescribed dosing regimen with the recommended dosing regimen for each of the patient's medications with a advisory if the prescribed regimen deviates from the dosing schedule recommended in, for example, the PDR monograph.

In addition to implementing the value functions, the server manages a database of pharmaceuticals for direct marketing (the Direct Marketing Medication List). Each of the named drugs in the Direct Marketing Medication List database contains named descriptors identifying the therapeutic class of the drug (Class Addition Descriptor), the drugs it could replace (Point Substitution Descriptor) and the combinations of drugs that it could replace (Group Substitution Descriptor). A Therapeutic Class Descriptor Database is also maintained allowing drugs from the Patient Medication List to be mapped into each drug's therapeutic class.

Value function (a) could help eliminate even obscure prescription errors from occurring. For example, the combination of meperidine with a mono-amine oxidase inhibitor as occurred in the highly publicized Libby Zion case at New York hospital in New York. Value function (b) could help patients effectively access the wide variety of Internet based retail sources of pharmaceuticals. Value function (c) could keep patients up to date on recent developments regarding their current medication or the therapeutic classes represented by their Patent Medication List, including newly discovered problems with their current therapy, clinical trials being conducted for drugs in the Patient Medication List or in the corresponding therapeutic class. Value function (d) could avoid problems such as the recent miss-transcription by a pharmacist of a hand written prescription which resulted in the dispensing of the wrong drug at the indicated dose resulting in the death of the patient.

A server-based program (Prescription Scan) then proceeds to parse the patient medication list as follows by associating with each drug in the Patient Medication List the therapeutic class of that drug. Then, the server-based application performs scans of both the Patent Medication List and the Direct Marketing Medication List, looking for the following matches:

Point Substitution Match

A condition where a drug in the Patient Medication List is named in Point Substitution Descriptor of one or more of the drugs in the Direct Marketing Medication List.

Group Substitution Match

A condition where more than one drug in the Patient Medication List appears in the Group Substitution Descriptor of one or more drugs in the Direct Marketing Medication List.

Class Addition Match

A condition where one or more drugs in the Patient Medication List appears in the Class Addition Descriptor of one or more drugs in the Direct Marketing Medication List.

Drugs in the Direct Marketing Medication List resulting in a Point Substitution Match will be presented by Prescription Scan as possible candidates for replacing a specific drug in the Patient Medication List. Drugs in the Direct Marketing Medication List resulting in a Group Substitution Match will be presented as possible candidates to replace a group of drugs in the Patient Medication List. Drugs in the Direct Marketing Medication List resulting in a Class Addition Match will be presented as possible drugs for addition to the current therapeutic program represented by the Patient Medication List.

The presentation of drugs listed in the Direct Marketing Medication List by Prescription Scan is done graphically to re-enforce patient identification with the brands being recommended. In particular, a graphic representing the generic name, brand name, or logo of a drug, or a picture of the drug container or actual dosage form or a combination of these is shown in close proximity to the Patient Medication List. In the case of a Point Substitution Match, the recommended drug or drugs from the Direct Marketing List are presented next to the drug in the Patient Medication List for which the Point Substitution is being recommended. In the case of a Group Substitution Match, the recommended drug or drugs from the Direct Marketing List are presented next to the Patient Medication List with the group of drugs being recommended for replacement highlighted. In the case of the Class Addition Match, the recommended drug or drugs from the Direct Marketing List are presented under or above the group of drugs in the matched therapeutic class.

In each case, it is understood that “presenting” a drug from the Direct Marketing List means displaying a graphic of the drug logo, brand name, generic name, packaging or dosage form or a combination of these.

The drugs in the Patient Medication List and the Direct Marketing List need not be limited to prescription medications. Medications entered by the patient as well as medications in the Direct Marketing Medication List could contain so called nutriceuticals including herbal remedies, vitamins, and over the counter medications.

These and other objects, advantages, and features of the invention will become apparent to those persons skilled in the art upon reading the details of the invention as more fully described below.

### DETAILED DESCRIPTION OF THE INVENTION

Before the present systems are described, it is to be understood that this invention is not limited to particular systems or methodologies described, as such may, of course, vary. It is also to be understood that the terminology used herein is for the purpose of describing particular embodiments only, and is not intended to be limiting, since the scope of the present invention will be limited only by the appended claims.

Where a range of values is provided, it is understood that each intervening value, to the tenth of the unit of the lower limit unless the context clearly dictates otherwise, between the upper and lower limits of that range is also specifically disclosed. Each smaller range between any stated value or intervening value in a stated range and any other stated or intervening value in that stated range is encompassed within the invention. The upper and lower limits of these smaller ranges may independently be included or excluded in the range, and each range where either, neither or both limits are included in the smaller ranges is also encompassed within the invention, subject to any specifically excluded limit in the stated range. Where the stated range includes one or both of the limits, ranges excluding either or both of those included limits are also included in the invention.

Unless defined otherwise, all technical and scientific terms used herein have the same meaning as commonly understood by one of ordinary skill in the art to which this invention belongs. Although any methods and materials similar or equivalent to those described herein can be used in the practice or testing of the present invention, the preferred methods and materials are now described. All publications mentioned herein are incorporated herein by reference to disclose and describe the methods and/or materials in connection with which the publications are cited.

It must be noted that as used herein and in the appended claims, the singular forms “a”, “and”, and “the” include plural referents unless the context clearly dictates otherwise. Thus, for example, reference to “a User” includes a plurality of such Users and reference to “the measurement” includes reference to one or more measurements and equivalents thereof known to those skilled in the art, and so forth.

The publications discussed herein are provided solely for their disclosure prior to the filing date of the present application. Nothing herein is to be construed as an admission that the present invention is not entitled to antedate such publication by virtue of prior invention. Further, the dates of publication provided may be different from the actual publication dates which may need to be independently confirmed.

Data processing on the Internet is characterized by the client-server model. Large, server systems continuously attached to the World Wide Web via high bandwidth connections contain application programs written using Hypertext Markup Language (HTML) accessible via unique addresses called Uniform Resource Locators (URLs). Client side systems have traditionally been personal computers running application programs called browsers, which allow communication between client and server via Hypertext Transfer Protocol (HTTP). The advent of generally available high speed wired and wireless connection between client and server systems has caused the computing paradigm to shift from local execution of self contained programs operating on local data to running server based application programs operating on server-based data or even on data resident throughout the world wide web.

This paradigm shift from local to remote data processing has decreased the requirement for computational resources at the client environment. As a result, clients able to communicate across the World Wide Web to servers now include small hand held computers, personal data assistants (PDAs), cellular telephones, and other wireless and wired portable communication technologies.

The client interface is by no means limited to a browser application program. Client-based application programs can seamlessly connect to the Internet and make use of information stored on the World Wide Web completely transparent to the end user.

Those skilled in the art could make and use the present invention using the disclosure described herein. However, in order to supplement such a disclosure particularly with respect to systems and computers used in connection with the present invention applicants incorporate by reference in their entirety the following U.S. Pat. Nos. 5,950,630, issued Sep. 14, 1999 entitled System and Method for Improving Compliance of a Medical Regiment; U.S. Pat. No. 5,845,255, issued Dec. 1, 1998 entitled Prescription Management System; U.S. Pat. No. 5,737,539, issued Apr. 7, 1998 entitled Prescription Creation System; U.S. Pat. No. 3,979,839, issued Sep. 14, 1976 entitled Drug Interaction System; U.S. Pat. No. 5,642,731, issued Jul. 1, 1997 entitled Method of and Apparatus for Monitoring the Management of Disease; U.S. Pat. No. 5,823,948, issued Oct. 20, 1998 entitled Medical Records, Documentation, Tracking and Order Entry System; U.S. Pat. No. 5,883,370, issued Mar. 16, 1999 entitled Automated Method for Filling Drug Prescriptions; U.S. Pat. No. 5,963,136, issued Oct. 5, 1999 entitled Interactive Prescription Compliance and Life Safety System; and U.S. Pat. No. 5,950,632, issued Sep. 14, 1999 entitled Medical Communication Apparatus, System, and Method.

The increasing breadth of technology capable of interfacing to the Internet enables multiple potential ways in which the Patient Data List can be entered into the server where the Prescription Scan application is resident. The Patient Data List could be manually entered one drug at a time using drug name, dosage size and dosing frequency. This process could be simplified through the use of a unique multi-digit code, which carried all of this information for each drug being taken. The process cold be automated via a bar code on each medication bottle which could be scanned by a bar code reader attached to the patient's computer or a Personal Data Assistant (PDA, e.g. 3com Palm Pilot). The process of entering medications in the Patient Data List into the Prescription Scan application could be completely automated through the use of a “Smart Medicine Cabinet” which reads machine readable labels, solid state digital memories or receives RF signals from transmitters attached to each medicine bottle. In this way, Prescription Scan is automatically updated each time a new medication bottle is placed into the medicine cabinet.

The electronic medicine cabinet disclosed and described herein could be produced using the technology known to those skilled in the art in combination with the description and disclosure provided here. However, in order to supplement such disclosure applicants incorporate by reference in their entirety the following U.S. Pat. Nos. 5,950,632, issued Sep. 14, 1999 entitled Medical Communication Apparatus System, and Method; U.S. Pat. No. 5,431,299, issued Jul. 11, 1995 entitled Medication Dispensing and Storing System with Dispensing Modules; U.S. Pat. No. 5,495,961, issued Mar. 5, 1996 entitled Portable Programmable Medication Alarm Device and Method and Apparatus for Programming and Using the Same; U.S. Pat. No. 5,713,485, issued Feb. 3, 1998 entitled Drug Dispensing System; U.S. Pat. No. 5,797,515, issued Aug. 25, 1998 entitled Method for Controlling a Drug Dispensing System; U.S. Pat. No. 5,912,818, issued Jun. 15, 1999 entitled System for Tracking and Dispensing Medical Items ; U.S. Pat. No. 5,993,046, issued Nov. 30, 1999 entitled System for Dispensing Medical Items by Brand or Generic Name; and U.S. Pat. No. 4,847,764, issued Jul. 11, 1989 entitled System for Dispensing Drugs in Health Care Institutions.

While the present invention has been described with reference to the specific embodiments thereof, it should be understood by those skilled in the art that various changes may be made and equivalents may be substituted without departing from the true spirit and scope of the invention. In addition, many modifications may be made to adapt a particular situation, material, composition of matter, process, process step or steps, to the objective, spirit and scope of the present invention. All such modifications are intended to be within the scope of the claims appended hereto.

What is claimed is:

1. In a computer system which implements a data receptor form on a screen which is accessible to a community of users, a method of analyzing data on a patient's prescribed pharmaceuticals, the method comprising the computer implemented steps of:
(a) providing user access to a community of user patients;
(b) generating a screen for user patient access wherein the screen prompts the user patient to manually enter data relating to drugs being taken by the user patient;
(c) obtaining data manually entered by the user patient as prompted;
(d) analyzing the data manually entered by the user patient; and
(e) producing a result based on the analysis.

2. The method of claim 1, wherein the user access is provided by means of world wide web access.

3. The method of claim 2, wherein the system is a browser-based system.

4. The method of claim 2, wherein the system is a software-based system.

5. The method of claim 1, wherein the manually entered data comprises data selected from the group consisting of: user name, age, sex, weight, height, race, current medications, medication dosages, time of meals, food eaten at meals, symptoms, insurance and caregiver name.

6. The method of claim 1, further comprising:
sending the result of the analysis to the user.

7. The method of claim 1, further comprising:
sending the result of the analysis to a caregiver.

8. The method of claim 1, wherein the data entered by the patient relating to drugs being taken by the user patient is analyzed relative a data bank of information on drugs.

9. The method of claim 8, wherein the results of the analysis describes a possible adverse drug combination being taken by the patient.

10. The method of claim 9, wherein the results of the analysis describe information on the effective shelf life of drugs being taken by the user patient.

11. The method of claim 1, wherein the manually entered data compared against a data bank of drugs and the results of the analysis describes alternative drugs for treating the user patient.

12. The method of claim 10, wherein the manually entered data compared against a data bank family of drug sellers and the results of the analysis describes prices for the drugs being taken by the user patient.

13. The method of claim 10, wherein the manually entered data compared against a data bank of potential drug interactions, possible drug sellers and possible alternative treatments.

14. The method of claim 1, wherein the results of the analysis is selected from the group consisting of:
(a) information on potential drug-drug interactions;
(b) information on retail sources of drugs and their price;
(c) current information on a drug being taken by the user patient; and
(d) a comparison of a standard dosing regimen for a drug being taken by the user patient with a dosing regimen being implemented by the user patient with an advisory if the user patient's dosing regimen exceeds the standard by a determined amount.

15. The method of claim 1, wherein the results of the analysis describes alternative drugs to those being taken by the user patient along with information on the price, potential benefits and potential adverse effects of the alternative drugs.

16. The method of claim 1, wherein the results of the analysis describes a single drug which could be substituted for two or more drugs currently being taken by the user patient.

17. The method of claim 1, wherein the results of the analysis describe a specific therapeutic class for each drug being taken by the user patient and lists other currently available drugs in each class.

18. The method of claim 1, wherein data is manually entered using a bar code reader and scanning a bar code on a medication of the user patient.

19. The method of claim 18 wherein the results produced comprises a display on the user patient's screen of the medication along with the name of the medication and its most common use thereby allowing the user patient to confirm a druggist has provided the corrected medication and that the medication is for an indication for which the user patient is being treated.

20. The method of claim 5, wherein a user patient profile is generated using the manually entered data.

21. The method of claim 20 wherein the results obtained describe alternate medications and an alternate dosing regimen based on the user patient profile.

22. The method of claim 1, further comprising:
connecting the system to a pharmacy computer and comparing manually entered data of the user patient against pharmacy computer data on the user patient.

23. The method of claim 1, further comprising:
connecting the system to a plurality of pharmacy computers to obtain information on pricing of medication of the user patient.

24. The method of claim 1, further comprising:
connecting the system to a remote pharmacy computer and obtaining information on possible adverse drug interactions on drugs being prescribed to the user patient.

25. The method of claim 1, further comprising:
storing drug containers for the drugs being taken by the user patient in an electronic medicine cabinet comprising a means for entering data inscribed on the container and uploading the data to the system.

26. The method of claim 25, wherein the means for entering data comprises a bar code scanner.

27. The method of claim 25, wherein a screen of the electronic medicine cabinet displays information on medications stored therein.

28. The method of claim 27 wherein the information displayed is selected from the group consisting of an image of the medication, a dosing regimen for the medication, precautions regarding use of the medication.
